(19) United States
(12) Patent Application Publication
(10) Pub. No.: US 2026/0186744 A1
(43) Pub. Date: Jul. 2, 2026

(54) BIT-SLICING METHOD AND DEVICE, AND DNN ACCELERATOR WITH SLICE-LEVEL SPARSITY EXPLOITATION BASED THEREON

(71) Applicant: UIF (University Industry Foundation), Yonsei University, Seoul (KR)

(72) Inventors: Joon-Sung YANG, Seoul (KR); Insu CHOI, Seoul (KR)

(21) Appl. No.: 19/433,530

(22) Filed: Dec. 26, 2025

(30) Foreign Application Priority Data
Dec. 30, 2024 (KR) 10-2024-0200946

(51) Int. Cl. G06F 7/544; G06F 7/48

(52) U.S. Cl. CPC G06F 7/5443; G06F 7/4824

(57) ABSTRACT

A bit-slicing method comprises: dividing input data into predetermined bit units to obtain a plurality of intermediate representation slice data; and sequentially obtaining higher-order slice data by adding, to a higher-order intermediate representation slice data, a sign bit that is a most significant bit of lower-order slice data obtained in a previous step and a carry bit generated in a process of obtaining the lower-order slice data.

### CROSS-REFERENCE TO RELATED APPLICATIONS

This application claims priority under 35 U.S.C. § 119 (a) to Korean Patent Application No. 10-2024-0200946, filed on Dec. 30, 2024, with the Korean Intellectual Property Office, the disclosure of which is incorporated herein in its entirety by reference.

### BACKGROUND

### 1. Technical Field

The disclosed embodiments relate to a bit-slicing method and device, and a deep neural network accelerator, and more particularly to a bit-slicing method and device that perform bit slicing in a two's complement format while preserving a bit width, and to a deep neural network accelerator that exploits slice-level sparsity based thereon.

### 2. Description of the Related Art

With the advent of various advanced models such as convolutional neural networks (CNN) and transformer models, deep neural networks, hereinafter referred to as DNNs, have been actively used in a wide range of fields. However, since DNNs require a very large amount of resources to perform massive MAC (multiply-and-accumulate) operations, various DNN accelerators have been studied to efficiently process such MAC operations. A DNN accelerator may adopt a bit-slicing technique to improve computational efficiency by repeatedly performing MAC operations on slice-level low-precision integers with respect to a DNN model quantized in an integer format.

In a multiplication operation of a MAC operation, when at least one of two data values has a value of zero, the multiplication result becomes zero, and thus the corresponding multiplication can be omitted. Accordingly, as the amount of data having a value of zero increases, the number of multiplication operations decreases, thereby improving computational efficiency. The bit-slicing technique divides data composed of a large bit width into a plurality of slice data each having a smaller bit width, and repeatedly performs MAC operations using the slice data. By performing bit slicing in this manner, not only can low-precision multipliers be utilized, but also, even when the original data is non-zero, some of the slice data may have a value of zero, thereby further reducing the actual number of multiplication operations.

However, when two's complement integer data is simply bit-sliced in units of a predetermined bit width, a sign is included only in a most significant slice data, whereas the remaining slice data do not include a sign. Accordingly, a separate sign bit needs to be added to the slice data other than the most significant slice data, which causes a problem in that a total bit width of the slice data becomes larger than a bit width of the original data. Recently, a technique has been proposed in which the most significant slice data is configured to have a bit width that is one bit larger than that of the other slice data, such that all slice data uniformly include a sign bit. However, even in this case, the number of slice data increases, resulting in an increase in the total bit width of the slice data. As a result, either a multiplier supporting a bit width one bit higher than that of the slice data is required, or the number of multiplication operations must be further increased, which imposes limitations on improving MAC operation efficiency.

### SUMMARY

An object of the disclosed embodiments is to provide a bit-slicing method and device capable of performing bit slicing in a two's complement format while preserving a bit width, and a deep neural network accelerator based thereon.

According to an embodiment, a bit-slicing method comprises: dividing input data into predetermined bit units to obtain a plurality of intermediate representation slice data; and sequentially obtaining higher-order slice data by adding, to a higher-order intermediate representation slice data, a sign bit that is a most significant bit of lower-order slice data obtained in a previous step and a carry bit generated in a process of obtaining the lower-order slice data.

Among the plurality of intermediate representation slice data, a least significant intermediate representation slice data may be obtained as a least significant slice data.

The input data and the plurality of obtained slice data may be integer-type data in a two's complement format.

According to an embodiment, a bit-slicing device comprises: a data register configured to receive and store input data; a plurality of slice data registers configured to store slice data; and an adder circuit configured to receive intermediate representation slice data obtained by dividing the input data into predetermined bit units, to receive a sign bit of lower-order slice data stored in a lower-order slice data register among the plurality of slice data registers and a carry bit generated in a process of obtaining the lower-order slice data, and to add the received bits to obtain the slice data.

According to an embodiment, a DNN accelerator comprises a plurality of processing elements, each processing element comprising: a front-end module configured to bit-slice a plurality of input data and a plurality of weight data, respectively, to obtain a plurality of input slice data and a plurality of weight slice data, to select slice data pairs to be used for MAC operations from among the plurality of input slice data and the plurality of weight slice data, and to collect and output only slice data pairs that do not include a zero value from among the selected slice data pairs; and a back-end module configured to perform MAC operations on the slice data pairs output from the front-end module.

The front-end module may comprise a plurality of slice selection modules configured to bit-slice a plurality of input data and a plurality of weight data, respectively, to obtain a plurality of input slice data and a plurality of weight slice data, and to selectively transmit the plurality of input slice data and the plurality of weight slice data; and a plurality of non-zero bit-slice collectors configured to detect and collect, from among a plurality of slice data pairs composed of the input slice data and the weight slice data selected by the plurality of slice selection modules, only non-zero slice data pairs in which both the input slice data and the weight slice data are non-zero.

The plurality of non-zero bit-slice collectors may comprise a plurality of non-zero selection modules each configured to receive a slice data pair and, when the received slice data pair is a non-zero slice data pair, to activate and output a selection signal; and a non-zero slice collection module configured to collect and output the slice data pairs received from the non-zero selection modules, among the plurality of non-zero selection modules, that output the activated selection signal.

The non-zero slice collection module may have a multi-stage hierarchical structure corresponding to a number of the plurality of non-zero selection modules, and may sequentially extract and collect, from among the plurality of slice data pairs, non-zero slice data pairs in an order from lower-order non-zero slice data pairs to higher-order non-zero slice data pairs based on arrangement positions of the plurality of non-zero selection modules, and output collected slice data pairs.

The non-zero slice collection module may comprise a plurality of data selectors provided in progressively smaller numbers as a hierarchy level increases, each data selector being configured to, in response to a selection signal or a combined selection signal, select and output one of a slice data pair applied from a non-zero selection module at a same position or a slice data pair selected at a higher-order position; a plurality of lower-order selection signal combiners each configured to receive, at a same hierarchy level and a same position, a selection signal or a combined selection signal applied to a corresponding data selector and a composite selection signal previously obtained at a lower-order position, and to perform a logical OR operation thereon to obtain a composite selection signal; and a plurality of hierarchical selection signal combiners each configured to receive, at a same hierarchy level and a same position, a selection signal or a combined selection signal applied to the corresponding data selector and the composite selection signal obtained by the lower-order selection signal combiners, and to perform a logical AND operation thereon to obtain the combined selection signal.

The slice selection module may comprise a bit-slicing module configured to receive input data or weight data and to perform bit slicing to obtain the plurality of input slice data or the plurality of weight slice data; and a bit-slicing selector configured to select the plurality of input slice data and the plurality of weight slice data in different combinations and to transmit the selected slice data pairs to the plurality of non-zero bit-slice collectors.

Accordingly, the bit-slicing method and device, and the deep neural network accelerator according to the embodiments are capable of performing bit slicing in a two's complement format while preserving a bit width, and, despite the two's complement format, increasing a number of slice data having a value of zero, thereby increasing a number of multiplications that can be omitted and significantly improving MAC operation efficiency of a DNN.

### BRIEF DESCRIPTION OF THE DRAWINGS

FIG. 1 is a diagram illustrating a concept of a bit-slicing technique according to an embodiment.

FIG. 2 illustrates an example of a bit-slicing device for performing the bit-slicing technique of FIG. 1.

FIG. 3 illustrates a schematic structure of a DNN accelerator according to an embodiment.

FIG. 4 illustrates a schematic configuration of a processing element in the DNN accelerator of FIG. 3.

FIG. 5 illustrates an example of a detailed configuration of a non-zero bit-slice collector of FIG. 4.

FIG. 6 illustrates an example of a detailed configuration of a non-zero slice selection module of FIG. 5.

FIG. 7 illustrates a cooperative spatial reuse method according to an embodiment.

FIG. 8 is a diagram for describing a computing environment including a computing device according to an embodiment.

### DETAILED DESCRIPTION

Hereinafter, specific embodiments of the present disclosure will be described with reference to the drawings. The following detailed description is provided to help with comprehensive understanding of a method, a device, and/or a system described in this specification. However, this is only an example, and the present invention is not limited thereto.

In describing embodiments of the present disclosure, when it is determined that detailed description of well-known technologies related to the present invention may unnecessarily obscure the gist of embodiments, the detailed description will be omitted. Terms to be described below are terms defined in consideration of functions in the present invention, and may vary depending on the intention, practice, or the like of a user or operator. Therefore, the terms should be defined on the basis of the overall content of this specification. Terms used in the detailed description are only used to describe embodiments and should not be construed as limiting. Unless otherwise clearly specified, a singular expression includes the plural meaning. In this description, an expression such as “include” or “have” is intended to indicate certain features, numerals, steps, operations, elements, or some or combinations thereof, and should not be construed as excluding the presence or possibility of one or more other features, numerals, steps, operations, elements, or some or combinations thereof. Also, the terms “unit,” “device,” “module,” “block,” and the like described in this specification refer to units for processing at least one function or operation, which may be implemented by hardware, software, or a combination of hardware and software.

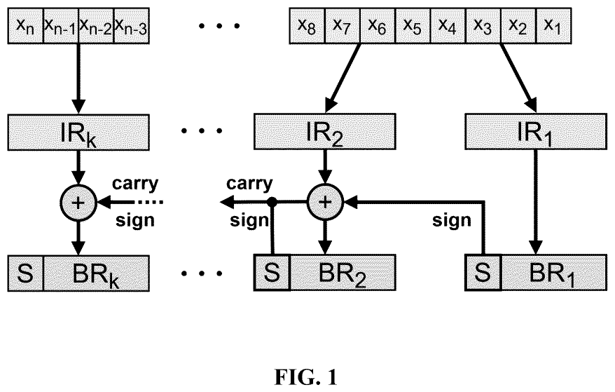

FIG. 1 is a diagram illustrating a concept of a bit-slicing technique according to an embodiment.

Referring to FIG. 1, an example is illustrated in which n-bit two's complement integer data is sliced into k slice data in units of m bits. In a bit-slicing technique according to an embodiment, first, similarly to a conventional bit-slicing technique, n-bit data is sliced and divided in units of m bits starting from a least significant bit (hereinafter referred to as an “LSB”), thereby generating k (k=n/m) intermediate representation slice data IR₁ to IRₖ. In this example, it is assumed that the data is sliced in units of 4 bits, that is, m equals 4, and accordingly, a bit width n of the data is assumed to be a multiple of 4. For example, when the data has a bit width of 16 bits, four slice data (k=16/4) may be obtained.

Among the generated k intermediate representation slice data IR₁ to IRₖ, a least significant intermediate representation slice data IR₁ is directly used as a slice data BR₁. However, for each of the remaining intermediate representation slice data IR₂ to IRₖ other than the least significant intermediate representation slice data IR₁, a slice data BR₂ to BRₖ is obtained by adding a sign bit S, which is a most significant bit (hereinafter referred to as an “MSB”) of a lower-order slice data BR₁ to BRₖ₋₁, and a carry bit. Referring to FIG. 1, first, an MSB, which is the sign bit S of the first slice data BR₁ serving as the least significant slice data, is added to the second intermediate representation slice data IR₂ to obtain a second slice data BR₂. In a process in which the sign bit S of the least significant slice data BR₁ is added to the second intermediate representation slice data IR₂ to obtain the second slice data BR₂, a carry bit generated by exceeding the bit unit of 4 bits (m=4) and the sign bit S of the second slice data BR₂ are used to obtain a higher-order third slice data BR₃.

The third slice data BR₃ is obtained by adding the carry bit and the sign bit S of the lower-order second slice data BR₂ to the third intermediate representation slice data IR₃, and the remaining higher-order slice data BR₄ to BRₖ may also be obtained by sequentially repeating a process of adding intermediate representation slice data IR₄ to IRₖ and a sign bit S and a carry bit of lower-order slice data BR₄ to BRₖ. However, the carry bit and the sign bit S cannot simultaneously have a value of one. Accordingly, only one of the sign bit S of the lower-order slice data BR₁ to BRₖ₋₁ or the carry bit generated in a process of obtaining the lower-order slice data BR₁ to BRₖ₋₁ may have a value of one. When either the sign bit S or the carry bit has a value of one, a higher-order slice data BR₂ to BRₖ is obtained as a value in which one is added to a corresponding intermediate representation slice data IR₂ to IRₖ. This process is repeatedly performed k−1 times from after the least significant slice data BR₁ is obtained until the most significant slice data BRₖ is obtained.

As an example, two's complement 16-bit data represented as ([0100 0111 1111 1110]₂) has a value of 18430. When the data is sliced in units of 4 bits, four intermediate representation slice data IR₁ to IR₄ are obtained as ([0100]₂, [0111]₂, [1111]₂, [1110]₂). In a conventional bit-slicing technique, since a sign bit S needs to be added to the intermediate representation slice data IR₁ to IR₄, slice data BR₁ to BR₄ are obtained as (([0100]₂, [00111]₂, [01111]₂, [01110]₂)=(4, 7, 15, 14)). That is, in the conventional bit-slicing technique, a total bit width of all slice data BR₁ to BR₄ is increased to 19 bits, which is an increase of 3 bits.

However, according to the bit-slicing technique of an embodiment illustrated in FIG. 1, slice data BR₁ to BR₄ are obtained as (([0101]₂, [1000]₂, [0000]₂, [1110]₂)=(5, −8, 0, −1)).

In this case, a sign bit S is not additionally appended to the slice data BR₁ to BR₄. Instead, an MSB of each of the slice data BR₁ to BR₄ is directly used as the sign bit S. Accordingly, a total bit width of all slice data BR₁ to BR₄ is maintained to be equal to a bit width of the original data, namely 16 bits.

Meanwhile, a plurality of slice data sliced according to a bit-slicing technique should be able to accurately represent a value of the original data. If the plurality of slice data accurately represents the data value, a sum obtained by multiplying each slice data BR₁ to BR₄ by a corresponding power of two associated with an LSB of each slice data BR₁ to BR₄ should be equal to the value of the original data.

When slice data BR₁ to BR₄ obtained using a conventional bit-slicing technique are restored to the original data, the original data is reconstructed as ((4×2¹²)+(7×2⁸)+(15×2⁴)+(14×2⁰)=18430). Likewise, when slice data BR₁ to BR₄ obtained using the bit-slicing technique of an embodiment are restored to the original data, the original data is reconstructed as ((5×2¹²)+(−8×2⁸)+(0×2⁴)+(−2×2⁰)=18430).

That is, it can be seen that the bit-slicing technique of an embodiment is capable of obtaining a plurality of slice data BR₁ to BR₄ sliced as two's complement integer data without an increase in bit width relative to a bit width of the original data.

The bit-slicing technique according to an embodiment may be applied in the same manner to negative values. By way of example, when original data is a negative 16-bit two's complement value ([1111 1111 1111 1000]₂=−8), the original data may be decomposed into four slice data (([0000]₂, [0000]₂, [0000]₂, [1000]₂)=(0, 0, 0, −8)). Notably, when the original data is a negative value close to zero, the number of slice data having a value of zero increases.

In DNNs, most weights generally follow a Gaussian distribution around zero. In addition, in a two's complement representation, negative values closer to zero tend to have a larger number of bits having a value of one. As a result, there are many negative weights having a large number of bits set to one, which frequently prevents multiplication operations from being omitted. However, when the bit-slicing technique according to an embodiment is applied, negative weights closer to zero yield an increased number of slice data having a value of zero, thereby significantly increasing the number of multiplications that can be omitted in a DNN. Accordingly, the MAC operation efficiency of the DNN can be greatly improved.

However, in the above-described bit-slicing technique, an overflow may occur during a process in which a sign bit and a carry bit of a lower-order slice data are added to a higher-order intermediate representation slice data, thereby changing a representable range of the two's complement integer data.

For example, when 8-bit integer data ([0111 1000]₂=120) is sliced in units of 4 bits, it may be converted into two slice data (([1000]₂, [1000]₂)=(−8, −8)). When the two slice data (([1000]₂, [1000]₂)) are reconstructed, a value of −136 (=(−8×2⁴)+(−8×2⁰)) is obtained instead of the original data value of 120. That is, due to overflow, the value 120 is changed to −136. Here, such an overflow issue can be suppressed by using a shifted integer representation range, in which a representation range of two's complement integer data according to a bit width is shifted by a range shift value (Δ) defined by Equation 1.

$$Δ = {{\sum }_{i = 0}}^{n / 4 - 2} {2}^{4 i + 3} \qquad [ Equation 1 ]$$

where n represents a bit width of the original data.

Due to a change in the representation range according to the range shift value (Δ), a range representable by n-bit data is changed from ([−2ⁿ⁻¹, 2ⁿ⁻¹−1]) to ([−2ⁿ⁻¹−4, 2ⁿ⁻¹−1−Δ]).

In addition, a DNN may be configured to perform MAC operations based on data (xᵢₙₜ) quantized in a two's complement integer format according to Equation 2.

$${x}_{int} = clip ( ⌊ \frac{x}{s} ⌉ , α , β ) \qquad [ Equation 2 ]$$

where xᵢₙₜ denotes quantized data, x denotes data to be quantized, s denotes a scale factor, and α and β denote a lower bound and an upper bound of a representation range, respectively. In an embodiment of the bit-slicing technique, α may be set to −2ⁿ⁻¹−Δ and β may be set to 2ⁿ⁻¹−1−Δ according to a modified representation range in which overflow does not occur.

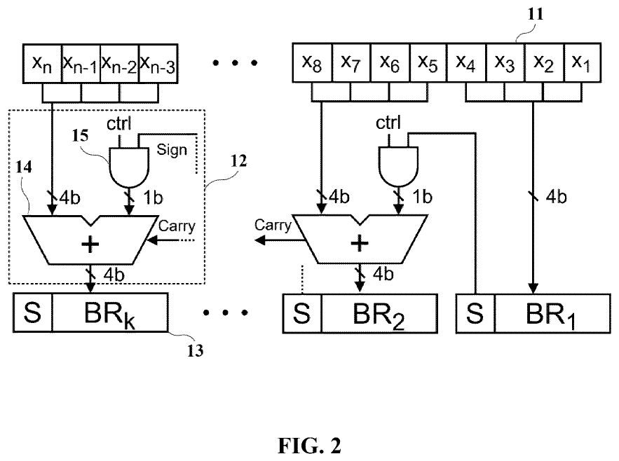

FIG. 2 illustrates an example of a bit-slicing device for performing the bit-slicing technique of FIG. 1.

Referring to FIG. 2, a bit-slicing device according to an embodiment may comprise a data register 11, a plurality of adder circuits 12, and a plurality of slice data registers 13.

The data register 11 receives data to be bit-sliced and temporarily stores the data. Here, it is assumed that n-bit data is sliced in units of m bits to obtain k (k=n/m) slice data BR₁ to BRₖ, and accordingly, the data register is configured to store n-bit data. The slice data registers are provided in a number of k to store the k slice data BR₁ to BRₖ, and each slice data register stores m-bit slice data BR₁ to BRₖ.

The plurality of adder circuits 12 are provided in a number of k−1, each corresponding to the remaining k−1 intermediate representation slice data IR₂ to IRₖ, among k intermediate representation slice data IR₁ to IRₖ obtained by dividing the n-bit data stored in the data register 11 into m-bit units starting from an LSB, excluding a least significant intermediate representation slice data IR₁. Each of the k−1 adder circuits 12 comprises an adder 14, and the adder 14 receives a corresponding one of the intermediate representation slice data IR₂ to IRₖ, excluding the least significant intermediate representation slice data IR₁, among the k intermediate representation slice data IR₁ to IRₖ. The adder 14 adds a sign bit S, which is an MSB of lower-order slice data BR₁ to BRₖ₋₁, and a carry bit generated during generation of the lower-order slice data BR₁ to BRₖ₋₁, to the received intermediate representation slice data IR₂ to IRₖ, thereby obtaining slice data BR₂ to BRₖ.

Along with this, each of the k−1 adder circuits 12 may further comprise an AND gate 15 that receives a sign bit S, which is an MSB of the lower-order slice data BR₁ to BRₖ₋₁, and a control signal ctrl, and performs a logical AND operation thereon. In the above description, the bit-slicing device has been described under the assumption that n-bit data is divided in units of m bits to obtain k slice data BR₁ to BRₖ. However, a DNN accelerator may use data of various bit widths, and in some cases, m-bit input data and weights may be used in a DNN accelerator configured to perform MAC operations on n-bit input data and weights. When the bit-slicing device is used in such a DNN accelerator, the bit-slicing device does not need to perform a bit-slicing operation, and instead, processing a plurality of m-bit input data and weights in parallel simultaneously further improves computational efficiency. As illustrated in FIG. 2, each of the k−1 adder circuits 12 further comprises an AND gate 15 that receives the sign bit S of the lower-order slice data BR₁ to BRₖ₋₁ and the control signal ctrl and performs a logical AND operation. When a bit width of the input data and the weights exceeds m bits, the sign bit S of the lower-order slice data BR₁ to BRₖ₋₁ is transmitted to the adder 14 according to the control signal ctrl having a value of 1 applied from a controller (not shown). On the other hand, when the bit width of the input data and the weights is equal to or less than m bits, a value of 0 is transmitted to the adder 14 regardless of the sign bit S of the lower-order slice data BR₁ to BRₖ₋₁ according to the control signal ctrl having a value of 0. When the sign bit S is not transmitted to the adder 14, a carry bit also cannot have a value of 1. Accordingly, the bit-slicing device is capable of transmitting input data and weights having a bit width equal to or less than m bits to a next circuit of the DNN without modification.

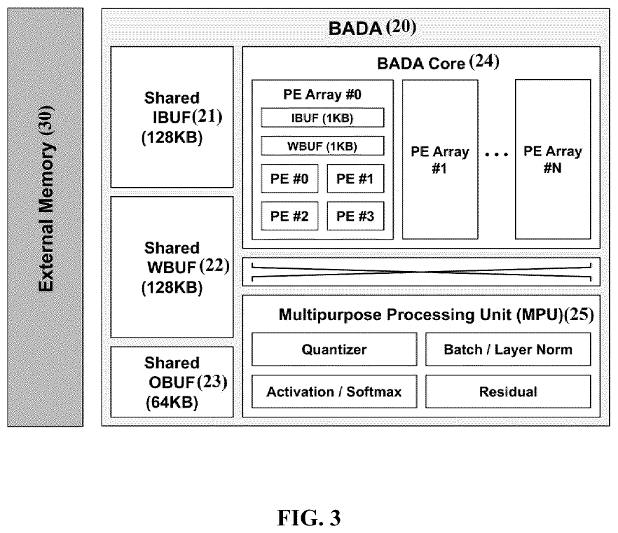

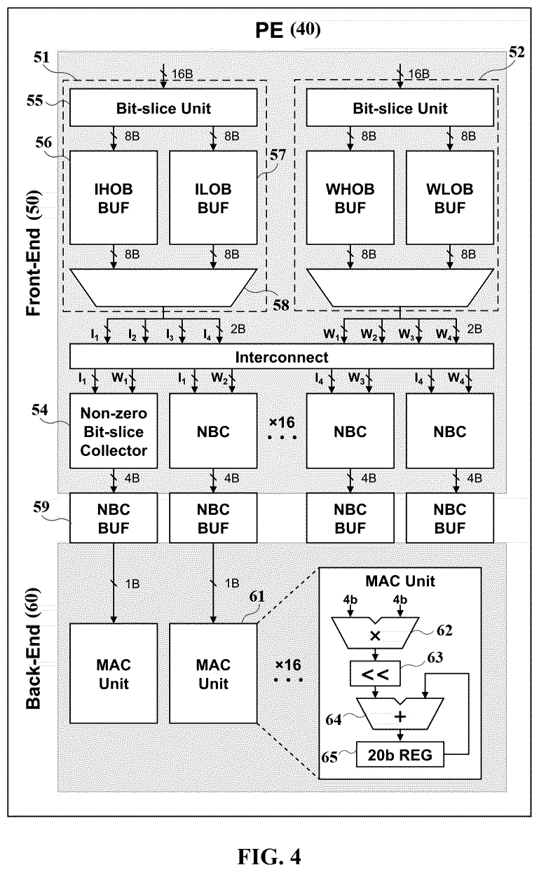

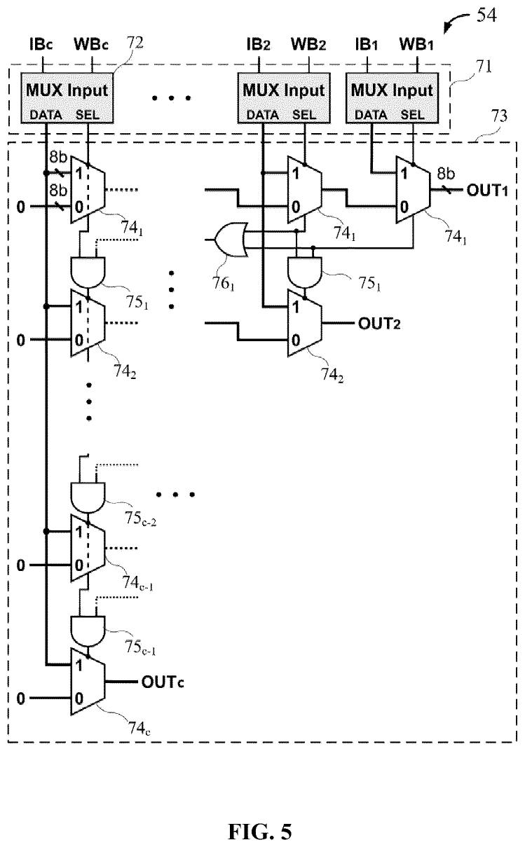

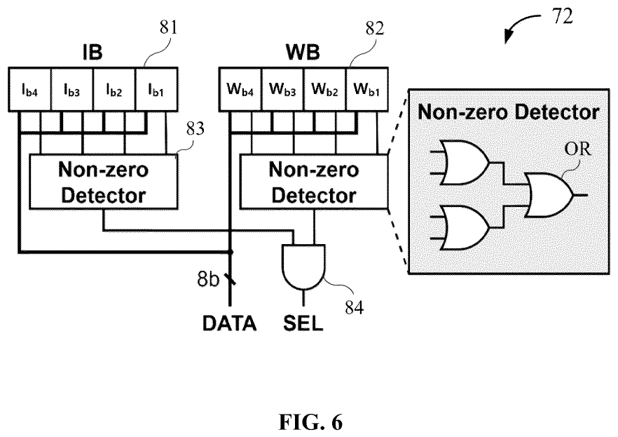

FIG. 3 illustrates a schematic structure of a DNN accelerator according to an embodiment, FIG. 4 illustrates a schematic configuration of a processing element in the DNN accelerator of FIG. 3, and FIG. 5 illustrates an example of a detailed configuration of a non-zero bit-slice collector of FIG. 4. In addition, FIG. 6 illustrates an example of a detailed configuration of a non-zero slice selection module of FIG. 5.

Referring to FIG. 3, a DNN accelerator 20 according to an embodiment may comprise three shared buffers 21 to 23, an operation core 24, and an MPU (Multipurpose Processing Unit) 25.

Among the three shared buffers 21 to 23, the shared input buffer 21 and the shared weight buffer 22 each receive input data and weights to be processed from an external memory 30 and temporarily store them, and transmit the stored input data and weights to the MPU 25 or the operation core 24. The shared output buffer 23 receives computation result data from the operation core 24 or the MPU 25 and temporarily stores the received result data, and then transmits the stored result data to the MPU 25, the operation core 24, or the external memory 30. That is, the three shared buffers 21 to 23 are shared and used by the operation core 24 and the MPU 25, and may perform interface communication with the external memory 30.

The operation core 24 comprises a plurality of processing element arrays (PE arrays), and each of the PE arrays may comprise an input buffer (IBUF) and a weight buffer (WBUF) for temporarily storing input data and weights received from the shared input buffer 21 and the MPU 25, respectively, and a plurality of processing elements (hereinafter referred to as an “PEs”) configured to perform MAC operations on the input data and weights stored in the input buffer IBUF and the weight buffer WBUF.

In one example, each PE array is assumed to receive an 8×8 input matrix and an 8×8 weight matrix to perform MAC operations and output an 8×8 output matrix. Each PE array includes four PEs (PE #0 to PE #3), and the MAC operations for the 8×8 input and weight matrices are divided among the four PEs such that each PE performs MAC operations on a 4×4 portion of the input and weight matrices. That is, each PE may be configured to receive 16 input data and 16 weights corresponding to the 4×4 input and weight matrices and perform MAC operations thereon.

Meanwhile, the MPU 25 may comprise a quantizer, a batch/layer normalization unit (Batch/Layer Norm), an activation/softmax unit (Activation/Softmax), and a residual computation unit (Residual).

The batch/layer normalization unit (Batch/Layer Norm) batches and normalizes the quantized input data and weights according to the structure of the DNN and transmits them to the operation core 24, and also recombines the computation results output from the operation core 24 to batch and normalize them according to the structure of the DNN. The activation/softmax unit (Activation/Softmax) receives MAC operation data computed by the operation core 24, applies an activation function, and performs a softmax operation. The residual computation unit (Residual) includes a high-precision fixed-point multiplier and adder to perform residual computations of the DNN that are not executed by the operation core 24. The quantizer (Quantizer) quantizes the results after the residual computations and stores them in the shared input buffer 21.

The DNN accelerator illustrated in FIG. 3, as is known, is configured to include a plurality of PEs 40 that each independently perform MAC operations, and each of the plurality of PEs 40 may be configured as shown in FIG. 4.

Referring to FIG. 4, PE 40 may be configured to comprise a front-end module 50 and a back-end module 60.

The front-end module 50 comprises an input slice selection module 51, a weight slice selection module 52, and a plurality of non-zero bit-slice collectors 54.

The input slice selection module 51 and the weight slice selection module 52 have the same configuration, each receiving a specified number of input data and weight data, bit-slicing the received input data and weight data into a plurality of input slice data and a plurality of weight slice data, and collecting the non-zero slice data excluding zero slice data having a value of zero from the plurality of input slice data and the plurality of weight slice data, and transmitting them to the back-end module 60.

Each of the input and weight slice selection modules 51 and 52 comprises a bit-slicing module 55, a higher-order slice buffer 56, a lower-order slice buffer 57, and a bit-slicing selector 58.

The bit-slicing module 55 may comprise a plurality of bit-slicing devices as illustrated in FIG. 2. In one example, it is assumed that the input and weight slice selection modules 51 and 52 each receive sixteen 8-bit input data and sixteen 8-bit weights from the input buffer IBUF and the weight buffer WBUF. Accordingly, sixteen bytes of input data and sixteen bytes of weight data may be applied to the input slice selection module 51 and the weight slice selection module 52, respectively.

Accordingly, each of the input and weight slice selection modules 51 and 52 may comprise sixteen bit-slicing devices in the bit-slicing module 55, each configured to bit-slice sixteen 8-bit input data and sixteen 8-bit weight data, respectively.

The bit-slicing module 55 bit-slices the sixteen 8-bit (n=8) input data and the sixteen 8-bit weight data in 4-bit units (m=4) to obtain two (k=8/4=2) slice data ((IHOB, ILOB), (WHOB, WLOB)). Among the two slice data obtained from each of the sixteen input data, the higher-order slice data is referred to as the input higher-order slice data (IHOB), and the lower-order slice data is referred to as the input lower-order slice data (ILOB). Likewise, among the two slice data obtained from each of the sixteen weight data, the higher-order slice data is referred to as the weight higher-order slice data (WHOB), and the lower-order slice data is referred to as the weight lower-order slice data (WLOB).

The bit-slicing module 55 may set a flag bit of 1 for slice data having a value of 0. In some cases, a controller (not shown) may check slice data having a value of 0 and set the flag bit of 1.

The input higher-order slice data IHOB and weight higher-order slice data WHOB are transmitted to and stored in the higher-order slice buffer 56, while the input lower-order slice data ILOB and weight lower-order slice data WLOB are stored in the lower-order slice buffer 57. Sixteen 4-bit input higher-order slice data IHOB and weight higher-order slice data WHOB are applied to the higher-order slice buffer 56, and sixteen 4-bit input lower-order slice data ILOB and weight lower-order slice data WLOB are applied to the lower-order slice buffer 57, so that 8 bytes of data are applied to and stored in each of the higher-order and lower-order slice buffers 56 and 57.

The bit-slicing selector 58 selects the sixteen 4-bit higher-order slice data IHOB and WHOB stored in the higher-order slice buffer 56 and the sixteen 4-bit lower-order slice data ILOB and WLOB stored in the lower-order slice buffer 57, and transmits them to a plurality of non-zero bit-slice collectors 54. The bit-slicing selector 58 may, for example, be implemented as a multiplexer, and can select the higher-order slice data IHOB and WHOB and the lower-order slice data ILOB and WLOB bit-sliced from the same input data or weight together and transmit them to the non-zero bit-slice collectors 54.

The bit-slicing selector 58 of the input slice selection module 51 is assumed to select, from each of two input data, two input higher-order slice data (IHOB) and two input lower-order slice data (ILOB) as one input data group, and the bit-slicing selector 58 of the weight slice selection module 52 is assumed to select, from each of two weight data, two weight higher-order slice data (WHOB) and two weight lower-order slice data (WLOB). The bit-slicing selector 58 of the input slice selection module 51 is assumed to select four input data groups (I₁ to I₄), and the bit-slicing selector 58 of the weight slice selection module 52 is assumed to select four weight data groups (W₁ to W₄).

When the flag bit of each slice data has a value of 1, the bit-slicing selectors 58 of the input slice selection module 51 and the weight slice selection module 52 may skip selecting the corresponding slice data and the slice data to be operated together with it. In this case, the bit-slicing selectors 58 may perform the skip operation under the control of a controller that determines the flag bit to have a value of 1.

The bit-slicing selectors 58 of the input and weight slice selection modules 51 and 52 apply the selected input data groups (I₁ to I₄) and weight groups (W₁ to W₄) to the plurality of non-zero bit-slice collectors 54 in all possible combinations ((I₁, W₁), (I₁, W₂), . . . , (I₄, W₃), (I₄, W₄)). Since 16 combinations are possible from the four input data groups (I₁ to I₄) and four weight groups (W₁ to W₄), it is assumed here that sixteen non-zero bit-slice collectors 54 are provided.

The non-zero bit-slice collectors 54 detect and collect non-zero data from the input data groups (I₁ to I₄) and weight groups (W₁ to W₄) selected and transmitted from the bit-slicing selectors 58 of the input and weight slice selection modules 51 and 52.

Referring to FIG. 5, the non-zero bit-slice collector 54 may comprise a non-zero slice selection module 71 and a non-zero slice collection module 73.

As shown in FIG. 6, the non-zero slice selection module 71 may comprise a plurality of non-zero selection modules 72. The non-zero slice selection module 71 may comprise a number of non-zero selection modules 72 corresponding to the number (c) of bit-sliced input data and weights transmitted from the bit-slicing selector 58. As described above, it is assumed here that each non-zero slice selection module 71 receives one of the input data groups I₁ to I₄, each consisting of two input data, and one of the weight groups W₁ to W₄, each consisting of two weights. The two input data and two weights are each sliced into two slice data. Accordingly, in one embodiment, the non-zero slice selection module 71 may comprise four (c=4) non-zero selection modules 72.

Each of the four non-zero selection modules 72 receives pairs ((IB₁, WB₁), . . . , (IB_{c}, WB_{c})) of input slice data and weight slice data that are to be multiplied, selected from four 4-bit input slice data (IB₁ to IB_{c}) of the input group and four 4-bit weight slice data (WB₁ to WB_{c}) of the weight group. The received slice data pairs ((IB₁, WB₁), . . . , (IB_{c}, WB_{c})) are transmitted to the non-zero slice collection module 73, while detecting data among the input slice data (IB₁ to IB_{c}) and weight slice data (WB₁ to WB_{c}) having non-zero values to generate a non-zero selection signal (SEL).

Referring to FIG. 6, each of the plurality of non-zero selection modules 72 may comprise an input register 81, a weight register 82, two non-zero detectors 83, and a selection signal generation circuit 84. The input register 81 and weight register 82 store slice data pairs (IB, WB) selected by the bit-slicing selector 58 of the input and weight slice selection modules 51 and 52, and transmit the stored slice data pairs (IB, WB) to the non-zero slice collection module 73. Each of the two non-zero detectors 83 receives input slice data (IB) stored in the input register 81 and weight slice data (WB) stored in the weight register 82, and determines whether each of the received input slice data (IB) and weight slice data (WB) has a zero value, thereby obtaining a detection signal. The non-zero detector 83 may, for example, be configured as a plurality of hierarchical OR gates as shown in the enlarged right-hand view. The non-zero detector 83, comprising a plurality of hierarchically arranged OR gates, activates the detection signal to 1 when at least one bit among the multiple bits (here, four bits) of each input slice data (IB) and weight slice data (WB) has a bit value of 1. In other words, when the input slice data (IB) and weight slice data (WB) have non-zero values, a detection signal of 1 is output.

The selection signal generation circuit 84 receives the detection signals obtained from the two non-zero detectors 83 and generates a selection signal (SEL). The selection signal generation circuit 84 may activate the selection signal (SEL) to 1 only when both of the received detection signals are 1. In other words, the selection signal generation circuit 84 outputs a selection signal (SEL) activated to 1 only when both the input slice data (IB) and weight slice data (WB) are non-zero, and outputs a selection signal (SEL) deactivated to 0 when at least one of the input slice data (IB) or weight slice data (WB) has a zero value. The selection signal generation circuit 84 may, for example, be implemented as an AND gate.

The non-zero slice collection module 73 collects and outputs only the slice data pairs that do not require a multiplication operation among the slice data pairs ((IB₁, WB₁), . . . , (IB_{c}, WB_{c})) transmitted from each of the multiple non-zero slice selection modules 72 of the non-zero slice selection module 71.

For example, among four slice data pairs ((IB₁, WB₁), . . . , (IB₄, WB₄)), when the second input slice data IB₂ and the third weight slice data WB₃ have a value of 0, the multiplication results of the second slice data pair (IB₂, WB₂) and the third slice data pair (IB₃, WB₃) become 0, so the multiplication operations can be omitted. However, even when it can be recognized in advance that the multiplication results are 0, when the recognized slice data pairs ((IB₂, WB₂), (IB₃, WB₃)) are transmitted together with slice data pairs whose multiplication results are non-zero ((IB₁, WB₁), (IB₄, WB₄)) to the back-end module 60, the back-end module 60 performs multiplication operations not only on the slice data pairs with non-zero results ((IB₁, WB₁), (IB₄, WB₄)) but also on the slice data pairs transmitted together ((IB₂, WB₂), (IB₃, WB₃)). In particular, when the number of MAC operators 61 provided in the back-end module 60 is limited and cannot perform MAC operations on all of the plurality of slice data pairs ((IB₁, WB₁), . . . , (IB₄, WB₄)) output from the plurality of non-zero bit-slice collectors 54 at once, the MAC operations must be repeatedly performed while changing the slice data pairs to be processed. Therefore, the computational efficiency of the back-end module 60 is reduced.

However, when the non-zero bit-slice collector 54 can exclude in advance slice data pairs ((IB₂, WB₂), (IB₃, WB₃)) whose multiplication results become 0 and whose multiplication operations can be omitted, and collect and transmit only the non-zero slice data pairs ((IB₁, WB₁), (IB₄, WB₄)) to the back-end module 60, the number of MAC operations can be reduced, thereby improving computational efficiency.

The non-zero slice collection module 73 may comprise a plurality of slice data selectors 741 to 74c, a plurality of hierarchical selection signal combiners 751 to 75c-1, and a plurality of higher-order selection signal combiners 761 to 76c-2.

As illustrated in FIG. 5, the non-zero slice collection module 73 may be configured as a hierarchical structure having a number of layers corresponding to a number of the plurality of non-zero selection modules. Each layer may sequentially extract and collect, from among the plurality of applied slice data pairs ((IB₁, WB₁), . . . , (IB_{c}, WB_{c})), slice data pairs starting from lower-order non-zero slice data pairs, and may output the collected slice data pairs.

In addition, in the non-zero slice collection module 73 configured as the hierarchical structure, as the number of layers increases, the numbers of the data selectors 741 to 74c, the hierarchical selection signal combiners 751 to 75c-1, and the lower-order selection signal combiners 761 to 76c-2 are gradually reduced, such that slice data pairs are sequentially collected starting from the least significant slice data pair (IB₁, WB₁) toward higher-order slice data pairs ((IB₁, WB₁), . . . , (IB_{c}, WB_{c})).

First, in a first layer, data selectors 741 are provided in a number c corresponding to the number of non-zero selection modules 72, and each of the c data selectors 741 selects and outputs one of slice data pairs applied from the non-zero selection modules 72 in response to a selection signal SEL, among slice data pairs ((IB₁, WB₁), . . . , (IB_{c}, WB_{c})) applied from the non-zero selection modules 72 and slice data pairs selected and applied from a data selector 741 positioned at a higher-order. In addition, in higher-order layers other than the first layer, as the layer increases, the number of data selectors 742 to 74c is gradually reduced by one and arranged at higher-order positions, and according to a combined selection signal applied from hierarchical selection signal combiners 751 to 75c-1 of the higher-order layers, one of slice data pairs ((IB₁, WB₁), . . . , (IB_{c}, WB_{c})) applied from the non-zero selection modules 72 and slice data pairs selected and applied from data selectors 742 to 74c positioned at higher-orders may be selected and output.

At this time, a data selector 741 to 74c positioned at a highest-order in each layer may be configured to select and output one of slice data pairs ((IB₁, WB₁), . . . , (IB_{c}, WB_{c})) applied from the non-zero selection modules 72 and a zero value. The data selectors 741 to 74c may be implemented as multiplexers (MUXs), by way of example.

In each layer, the lower-order selection signal combiners (761 to 76c-2) receive a selection signal or a combined selection signal applied to a data selector (741 to 74c-2) at the same position in the same layer, and a composite selection signal output from a lower-positioned lower-order selection signal combiner (761 to 76c-2), perform a logical OR operation to obtain a composite selection signal, and output the obtained composite selection signal to an higher-positioned lower-order selection signal combiner (761 to 76c-2). Here, the lower-order selection signal combiners (761 to 76c-2) may be implemented, by way of example, as OR gates.

Further, in each layer, the hierarchical selection signal combiners (751 to 75c-1) receive a selection signal or a combined selection signal applied to a data selector (741 to 74c-2) at the same position in the same layer, and the composite selection signal obtained from the lower-order selection signal combiners (761 to 76c-2), perform a logical AND operation to obtain a combined selection signal, and apply the obtained combined selection signal to a data selector (741 to 74c-2) located in a next layer.

The non-zero slice collection module 73 having such a configuration sequentially shifts, in a lower-order direction, and collects slice data pairs ((IB₁, WB₁), . . . , (IB_{c}, WB_{c})) whose multiplication results are non-zero from among a plurality of slice data pairs ((IB₁, WB₁), . . . , (IB_{c}, WB_{c})), starting from the least significant slice data pair (IB_{c}, WB_{c}), according to selection signals (SEL) output from the c non-zero selection modules 72 of the non-zero slice selection module 71, and outputs the collected slice data pairs.

If, as in the above-described example, among the slice data pairs ((IB₁, WB₁), . . . , (IB₄, WB₄)), the second input slice data (IB₂) and the third weight slice data (WB₃) have a value of 0 such that the multiplication results for the second and third slice data pairs ((IB₂, WB₂), (IB₃, WB₃)) are recognized as being 0, then, without using the non-zero slice collection module 73, slice data pairs ((IB₁, WB₁), (0, WB₂), (IB₃, 0), (IB₄, WB₄)) are output as four output signals (OUT₁ to OUT₄), making it difficult to improve computational efficiency. However, when the non-zero slice collection module 73 shown in FIG. 5 is used, the non-zero slice collection module 73, by selection signals (SEL) deactivated to 0, can collect and output only two non-zero slice data pairs ((IB₁, WB₁), (IB₄, WB₄)) as two output signals (OUT₁, OUT₂).

The slice data pairs ((IB₁, WB₁), (IB₄, WB₄)) collected by the plurality of non-zero bit-slice collectors 54 may be temporarily stored in a non-zero bit-slice collection buffer 59 and then transmitted to the backend module 60. Although the non-zero bit-slice collection buffer 59 is illustrated here as being configured separately from the front-end module 50, the non-zero bit-slice collection buffer 59 may be included in the front-end module 50.

The slice data pairs ((IB₁, WB₁), (IB₄, WB₄)) collected by the plurality of non-zero bit-slice collectors 54 are transmitted to the backend module 60, where MAC operations are performed. The backend module 60 comprises a plurality of MAC operators 61. Each of the plurality of MAC operators 61 receives one of the slice data pairs ((IB₁, WB₁), (IB₄, WB₄)) collected by the non-zero bit-slice collectors 54 of the front-end module 50 and performs a MAC operation. Each of the plurality of MAC operators 61 may comprise a multiplier 62, a shifter register 63, an adder 64, and a register 65. Since the configuration of the MAC operator 61 is the same as that of a conventional MAC operator, a detailed description of the operation of the MAC operator 61 will be omitted herein.

As a result, in the DNN accelerator according to an embodiment illustrated in FIG. 3, a plurality of intermediate representation slice data obtained by evenly bit-slicing applied input data and weights in units of bits of a predetermined size are each added with a sign bit or a carry bit of a lower-order slice data, thereby obtaining bit-sliced slice data. Accordingly, while maintaining the bit width, input slice data and weight slice data that are bit-partitioned in a two's complement format are obtained, and MAC operations are performed using the same. In this case, since the number of bits having a bit value of 0 increases in negative values close to 0, which have a high occurrence frequency in the input slice data and the weight slice data, the number of multiplication operations that can be omitted increases.

Further, by comprising the non-zero bit-slice collector 54, when at least one of the input slice data and the weight slice data has a value of zero, such slice data is detected in advance and excluded, and only the remaining input slice data and weight slice data having non-zero values are transmitted to the backend module 60, thereby preventing the backend module 60 from performing unnecessary MAC operations. As a result, the DNN accelerator can intensively perform MAC operations only on input slice data and weight slice data having non-zero values, thereby significantly improving the MAC operation efficiency of the DNN accelerator.

In the illustrated embodiment, respective configurations may have different functions and capabilities in addition to those described above, and may include additional configurations in addition to those described above. In addition, in an embodiment, each configuration may be implemented using one or more physically separated devices, or may be implemented by one or more processors or a combination of one or more processors and software, and may not be clearly distinguished in specific operations unlike the illustrated example.

In addition, the bit-slicing device illustrated in FIG. 2 and the DNN accelerator illustrated in FIG. 3 may be implemented in a logic circuit by hardware, firm ware, software, or a combination thereof or may be implemented using a general purpose or special purpose computer. The apparatus may be implemented using hardwired device, field programmable gate array (FPGA) or application specific integrated circuit (ASIC). Further, the apparatus may be implemented by a system on chip (SoC) including one or more processors and a controller.

In addition, the bit-slicing device and the DNN accelerator may be mounted in a computing device or server provided with a hardware element as a software, a hardware, or a combination thereof. The computing device or server may refer to various devices including all or some of a communication device for communicating with various devices and wired/wireless communication networks such as a communication modem, a memory which stores data for executing programs, and a microprocessor which executes programs to perform operations and commands.

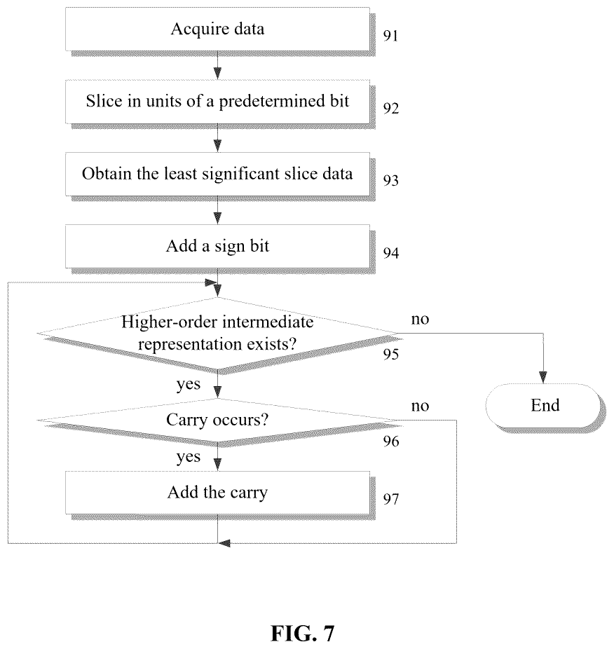

FIG. 7 illustrates a cooperative spatial reuse method according to an embodiment.

Referring to FIG. 7, a bit-slicing method according to an embodiment first acquires data to be subjected to bit-slicing (91). Here, it is assumed that the acquired data is n-bit data. The acquired data is sliced in units of a predetermined bit width m to obtain k (k=n/m) intermediate representation slice data IR₁ to IRₖ (92).

Among the acquired k intermediate representation slice data IR₁ to IRₖ, the least significant intermediate representation slice data IR₁ is directly obtained as the bit-sliced least significant slice data BR₁ (93). Then, a sign bit, which is a most significant bit of the least significant slice data BR₁, is added to a higher-order intermediate representation slice data IR₂ among the k intermediate representation slice data IR₁ to IRₖ to obtain a higher-order slice data BR₂ (94). Thereafter, it is determined whether a higher-order intermediate representation slice data exists (95). When it is determined that a higher-order intermediate representation slice data exists, it is determined whether a carry bit has occurred in the process of obtaining the previous slice data BR₂ (96). When it is determined that a carry bit has occurred, the carry generated in the process of obtaining the previous slice data BR₂ is added to the higher-order intermediate representation slice data IR₂ (97). Then, the sign bit, which is the most significant bit of the previous slice data BR₂, is added again to obtain a higher-order slice data BR₃ (94). By repeating the above process, higher-order slice data BR₃ to BRₖ are sequentially obtained, and when the k-th slice data BRₖ is obtained and no higher-order intermediate representation slice data exists, the bit-slicing process is terminated.

In FIG. 7, it is described that respective processes are sequentially executed, which is, however, illustrative, and those skilled in the art may apply various modifications and changes by changing the order illustrated in FIG. 7 or performing one or more processes in parallel or adding another process without departing from the essential gist of the exemplary embodiment of the present disclosure.

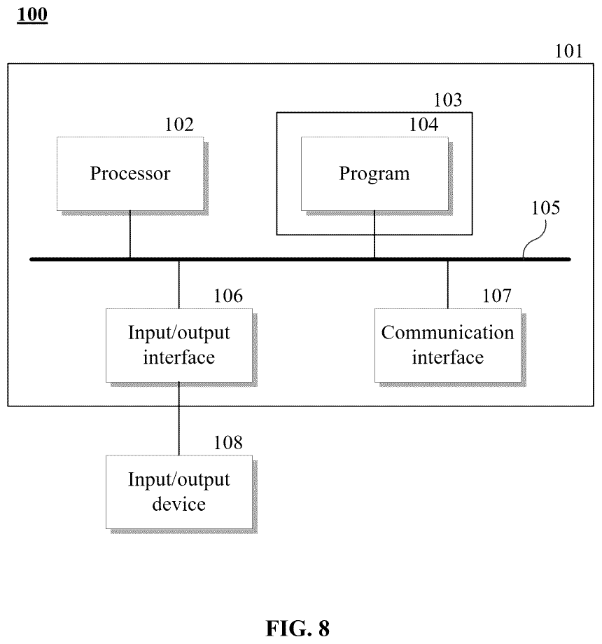

FIG. 8 is a diagram for describing a computing environment including a computing device according to an embodiment.

In the illustrated embodiment, respective configurations may have different functions and capabilities in addition to those described below, and may include additional configurations in addition to those described below. The illustrated computing environment 100 may include a computing device 101 to perform the bit-slicing method illustrated in FIG. 7.

The computing device 101 includes at least one processor 102, a computer readable storage medium 103 and a communication bus 105. The processor 102 may cause the computing device 101 to operate according to the above-mentioned exemplary embodiment. For example, the processor 102 may execute one or more programs 104 stored in the computer readable storage medium 103. The one or more programs 104 may include one or more computer executable instructions, and the computer executable instructions may be configured, when executed by the processor 102, to cause the computing device 101 to perform operations in accordance with the exemplary embodiment.

The communication bus 105 interconnects various other components of the computing device 101, including the processor 102 and the computer readable storage medium 103.

The computing device 101 may also include one or more input/output interfaces 106 and one or more communication interfaces 107 that provide interfaces for one or more input/output devices 108. The input/output interfaces 106 and the communication interfaces 107 are connected to the communication bus 105. The input/output devices 108 may be connected to other components of the computing device 101 through the input/output interface 106. Exemplary input/output devices 108 may include input devices such as a pointing device (such as a mouse or trackpad), keyboard, touch input device (such as a touchpad or touchscreen), voice or sound input device, sensor devices of various types and/or photography devices, and/or output devices such as a display device, printer, speaker and/or network card. The exemplary input/output device 108 is one component constituting the computing device 101, may be included inside the computing device 101, or may be connected to the computing device 101 as a separate device distinct from the computing device 101.

The present invention has been described in detail through a representative embodiment, but those of ordinary skill in the art to which the art pertains will appreciate that various modifications and other equivalent embodiments are possible. Therefore, the true technical protection scope of the present invention should be defined by the technical spirit set forth in the appended scope of claims.

What is claimed is:

1. A deep neural network (DNN) accelerator comprising a plurality of processing elements,
the plurality of processing element comprising:
a front-end module configured to bit-slice a plurality of input data and a plurality of weight data, respectively, to obtain a plurality of input slice data and a plurality of weight slice data, to select slice data pairs to be used for multiply-and-accumulate (MAC) operations from among the plurality of input slice data and the plurality of weight slice data, and to collect and output only slice data pairs that do not include a zero value from among the selected slice data pairs; and
a back-end module configured to perform the MAC operations on the slice data pairs output from the front-end module.

2. The DNN accelerator according to claim 1,
wherein the front-end module comprises:
a plurality of slice selection modules configured to bit-slice a plurality of input data and a plurality of weight data, respectively, to obtain the plurality of input slice data and the plurality of weight slice data, and to selectively transmit the plurality of input slice data and the plurality of weight slice data; and
a plurality of non-zero bit-slice collectors configured to receive a plurality of slice data pairs composed of input slice data and weight slice data selected by the plurality of slice selection modules, and to detect and collect, from among the plurality of slice data pairs, non-zero slice data pairs in which both the input slice data and the weight slice data are non-zero.

3. The DNN accelerator according to claim 2,
wherein the non-zero bit-slice collectors comprise:
a plurality of non-zero selection modules each configured to receive a slice data pair and, when the received slice data pair is a non-zero slice data pair, to activate and output a selection signal; and
a non-zero slice collection module configured to collect and output the slice data pairs received from the non-zero selection modules, among the plurality of non-zero selection modules, that output the activated selection signal.

4. The DNN accelerator according to claim 3,
wherein the non-zero slice collection module
has a multi-stage hierarchical structure corresponding to a number of the plurality of non-zero selection modules, and
sequentially extracts and collects, from among the plurality of slice data pairs, non-zero slice data pairs in an order from lower-order non-zero slice data pairs to higher-order non-zero slice data pairs based on arrangement positions of the plurality of non-zero selection modules, and output collected slice data pairs.

5. The DNN accelerator according to claim 3,
wherein the non-zero slice collection module comprises:
a plurality of data selectors provided in progressively smaller numbers as a hierarchy level increases, each data selector being configured to, in response to the selection signal or a combined selection signal, select and output one of a slice data pair applied from the non-zero selection module at a same position or a slice data pair selected at a higher-order position;
a plurality of lower-order selection signal combiners each configured to receive, at the same hierarchy level and the same position, a selection signal or a combined selection signal applied to a corresponding data selector and a composite selection signal previously obtained at a lower-order position, and to perform a logical OR operation thereon to obtain a composite selection signal; and
a plurality of hierarchical selection signal combiners each configured to receive, at the same hierarchy level and the same position, a selection signal or a combined selection signal applied to the corresponding data selector and the composite selection signal obtained by the lower-order selection signal combiners, and to perform a logical AND operation thereon to obtain the combined selection signal.

6. The DNN accelerator according to claim 2,
wherein the slice selection module comprises:
a bit-slicing module configured to receive the input data or the weight data and to perform bit-slicing to obtain the plurality of input slice data or the plurality of weight slice data; and
a bit-slicing selector configured to select the plurality of input slice data and the plurality of weight slice data in different combinations and to transmit the selected slice data pairs to the plurality of non-zero bit-slice collectors.

7. The DNN accelerator according to claim 6,
wherein the bit-slicing module
divides input data among the input data or the weight data into predetermined bit units to obtain a plurality of intermediate representation slice data, and
sequentially obtains higher-order slice data by adding, to a higher-order intermediate representation slice data, a sign bit that is a most significant bit of a previously obtained lower-order slice data and a carry bit generated in a process of obtaining the lower-order slice data.

8. The DNN accelerator according to claim 7,
wherein the least significant intermediate representation slice data among the plurality of intermediate representation slice data is obtained as a least significant slice data.

9. The DNN accelerator according to claim 7,
wherein the input data, the weight data, and the plurality of slice data are integer data in two's complement format.
